(19) United States
(12) Patent Application Publication
(10) Pub. No.: US 2011/0293243 A1
(43) Pub. Date: Dec. 1, 2011

(54) MULTIMEDIA PLAYING APPARATUS AND MULTIMEDIA DATA CONVERTER AND CONVERTING METHOD THEREOF

(75) Inventors: Yi-Ming Huang, Hsinchu City (TW); Yu-Chih Chen, Hsinchu City (TW); Chien-Hao Chen, Hsinchu City (TW)

(73) Assignee: SUNPLUS TECHNOLOGY CO., LTD., Hsinchu (TW)

(21) Appl. No.: 12/837,453

(22) Filed: Jul. 15, 2010

(30) Foreign Application Priority Data
Jun. 1, 2010 (TW) 99117588

(51) Int. Cl. H04N 9/80

(52) U.S. Cl. 386/247; 386/E09.011

(57) ABSTRACT

A multimedia data converter for converting a transport stream to a program stream is provided, which includes a storage unit and a recorder. The storage unit includes a plurality of storage blocks. The recorder selects a plurality of transport stream packets from the transport stream, and determines whether the selected transport stream packet includes the multimedia data. Besides, the recorder directly stores the multimedia data to the storage unit by using the divided storage blocks, so as to reduce a loading of system performance.

### CROSS-REFERENCE TO RELATED APPLICATION

This application claims the priority benefit of Taiwan application serial no. 99117588, filed on Jun. 1, 2010. The entirety of the above-mentioned patent application is hereby incorporated by reference herein and made a part of specification.

### BACKGROUND OF THE INVENTION

1. Field of the Invention

The invention relates to a multimedia playing apparatus, a multimedia data converter and a method for converting multimedia data. More particularly, the invention relates to a multimedia playing apparatus, a multimedia data converter and a method for converting multimedia data for converting a transport stream into a program stream.

2. Description of Related Art

With advent of the digital age, telecast is gradually developed from a conventional analog system to a digital system. The present global digital television standards are developed into three main types including the European digital video broadcasting (DVB), the American advanced television system communication (ATSC) and the Japanese integrated services digital broadcasting (ISDB). Wherein, the digital terrestrial television broadcasting of Taiwan region uses a European DVB-T standard, which has become popular under the impetus of the government.

Under the DVB-T standard, a transceiver of a digital television system converts multimedia data of a program source into packets complied with MPEG-2 transport stream for transmission. However, a general packaging method is to convert the multimedia data into packets complied with MPEG-2 program stream. Therefore data format conversion between the transport stream and the program stream is an indispensable part in application.

Regarding the multimedia data conversion, since new packets are required to be constructed, the system requires additional storage blocks or memory blocks suitable for the packet size for collecting elementary (video or audio) stream data. Then, after the storage blocks or the memory blocks collect a certain amount of data, an output sequence of the packet is determined, and then a transport packet header and a system clock reference (SCR) of the packet is set, so as to complete constructing the new packet. Thereafter, the new packet is copied to a file or another integrated memory for utilization.

In other words, according the conventional technique, besides the storage blocks or the memory blocks suitable for the packet size have to be used to collect the elementary stream data, the data has to be copied to a post-end file or an integrated memory. Therefore, an intermediate process has to be consumed to execute the data copy operation after the packet is constructed. Comparatively, the higher the bit rate of the multimedia data is, the higher the system performance is required by the data copy operation for moving data, so that a loading of the system performance is increased.

### SUMMARY

The invention is directed to a multimedia data converter, which is used for mitigating a loading of system performance.

The invention is directed to a multimedia playing apparatus, which is used for mitigating a performance loading of an embedded system.

The invention is directed to a method for converting multimedia data, which is used for saving a data copy operation in an intermediate process, so as to increase a system performance.

The invention provides multimedia data converter for converting a transport stream to a program stream, the multimedia data converter includes a storage unit and a recorder. The storage unit includes a plurality of storage blocks, wherein the storage blocks respectively store a program stream packet used for forming the program stream, and the storage blocks are respectively set to an idle state, a collecting state or a completed state. The recorder selects a plurality of transport stream packets from the transport stream, and determines whether each of the selected transport stream packets includes a multimedia data.

Besides, the recorder selects a first storage block having the collecting state from the storage blocks for storing the multimedia data, and determines whether or not to select a second storage block having the idle state from the storage blocks in sequence according to remained memory space of the first storage block, so as to use the first storage block or the second storage block to store the multimedia data. Wherein, when the second storage block is selected, the recorder sets a system clock reference of the program stream packet stored in the second storage block, and fills a program header of the program stream packet stored in the second storage block.

In an embodiment of the present invention, the recorder further determines whether the first storage block exists. Wherein, if the first storage block does not exist, the recorder searches the second storage block for directly storing the multimedia data to the second storage block. If the first storage block exists, the recorder stores a part of the multimedia data to the first storage block, and determines whether a memory space of the first storage block is fully filled. Moreover, if the memory space of the first storage block is not fully filled, the recorder stores the remained multimedia data to the first storage block, and if the memory space of the first storage block is fully filled, the recorder switches the first storage block from the collecting state to the completed state, and searches the second storage block, so as to store the remained multimedia data to the second storage block.

The invention provides a multimedia playing apparatus including the above multimedia data converter, a memory and a player. The above multimedia data converter converts a transport stream to a program stream. Moreover, the memory extracts and stores the program stream received from the multimedia data converter according to a valid storable data memory address. The player decodes the transport stream or the program stream to directly play the multimedia data in the transport stream or play the multimedia data in the program stream stored in the memory.

The invention provides a method for converting multimedia data, which is used for converting a transport stream to a program stream, and includes following steps.

A plurality of storage blocks is provided, wherein the storage blocks respectively store a program stream packet used for forming the program stream, and the storage blocks are respectively set to an idle state, a collecting state or a completed state. A plurality of transport stream packets is selected from the transport stream, and it is determined whether each of the selected transport stream packets includes a multimedia data. A first storage block having the collecting state is selected from the storage blocks for storing the multimedia data, and it is determined whether or not to select a second storage block having the idle state from the storage blocks in sequence according to remained memory space of the first storage block, so as to use the first storage block or the second storage block to store the multimedia data. Then, when the second storage block is selected, a system clock reference of the program stream packet stored in the second storage block is set, and a program header of the program stream packet stored in the second storage block is filled.

According to the above descriptions, the second storage unit is used to provide a plurality of storage blocks. Moreover, when the program stream packets are collected, the multimedia data is directly stored to the divided storage blocks in sequence and a sequence and time information of the program stream packet are determined when the storage block is selected. In this way, utilization of a memory used for collecting data during the intermediate process in the conventional technique is unnecessary, and data copy operation executed after the program stream packet is constructed can be saved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a circuit schematic diagram illustrating a multimedia playing apparatus according to an embodiment of the invention.

FIG. 1B is a structural schematic diagram illustrating a multimedia data converter according to an embodiment of the invention.

FIG. 2 is a schematic diagram illustrating a structure of a transport stream of FIG. 1B.

FIG. 3 is a flowchart illustrating an operation of a recorder according to an embodiment of the invention.

### DETAILED DESCRIPTION OF DISCLOSED EMBODIMENTS

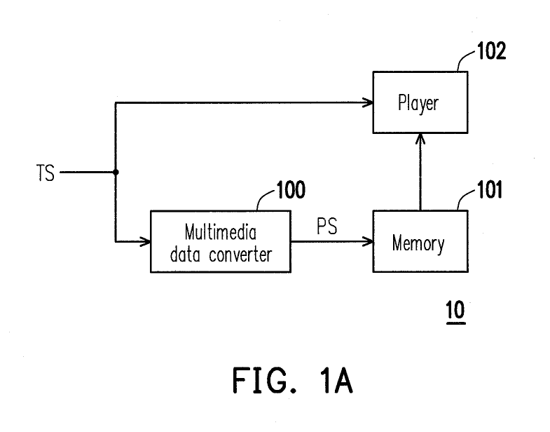

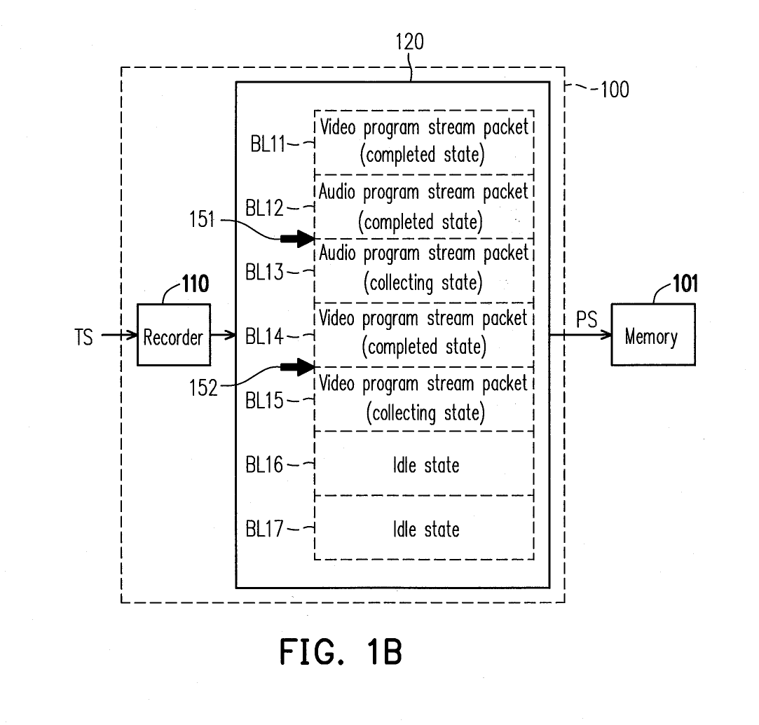

FIG. 1A is a circuit schematic diagram illustrating a multimedia playing apparatus according to an embodiment of the invention. Referring to FIG. 1A, the multimedia playing apparatus 10 includes a multimedia data converter 100, a memory 101 and a player 102. The multimedia data converter 100 converts a transport stream to a program stream. Moreover, the memory 101 extracts and stores the program stream received from the multimedia data converter 100 according to a valid storable data memory address. On the other hand, the player 102 decodes the transport stream or the program stream to directly play the multimedia data in the transport stream or play the multimedia data in the program stream stored in the memory 101. Therefore, in an actual application, the multimedia playing apparatus 10 can record user's favourite program in real time or according to a schedule through the multimedia data converter 100 and the memory 101. Comparatively, the user can watch the program recorded in real time or according to a schedule through the multimedia playing apparatus 10.

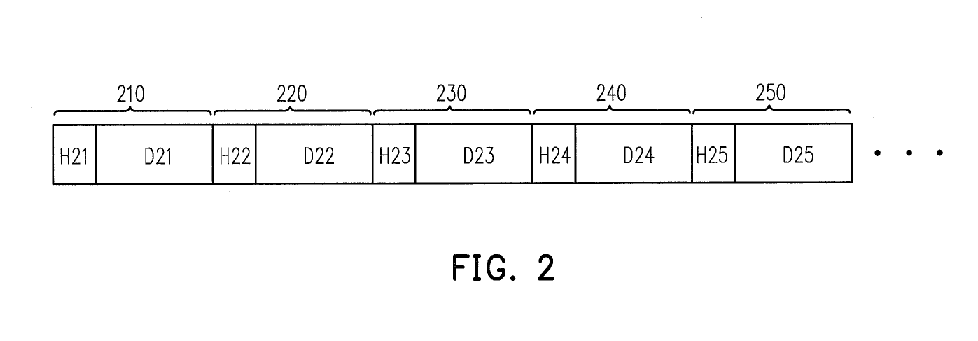

FIG. 1B is a structural schematic diagram illustrating a multimedia data converter according to an embodiment of the invention, in which the memory 101 is further illustrated. Referring to FIG. 1B, the multimedia data converter 100 includes a recorder 110 and a storage unit 120. Before a converting mechanism of the multimedia data converter 100 is introduced, composition of the transport stream is first introduced. FIG. 2 is a schematic diagram illustrating a structure of a transport stream of FIG. 1B. As shown in FIG. 2, the transport stream includes a plurality of transport stream packets, for example, the transport stream packets 210-250, and each of the transport stream packets 210-250 includes a transport packet header and a packet payload. For example, the transport stream packet 210 includes a transport packet header H21 and a packet payload D21. Moreover, a size of the transport stream packet is 188 bytes, wherein a size of the transport packet header is 4 bytes, and a size of the packet payload is 184 bytes.

It should be noticed that the transport packet header of each of the transport stream packets includes a plurality of important fields for recording bit values of related control information such as, transport scrambling control, a packet identification code(PID), adaptation field control, and a payload unit start indicator, etc. The transport stream packets 210-250 of FIG. 2 are taken as an example to introduce the multimedia data converter 100.

Referring to FIG. 1B and FIG. 2, the recorder 110 first receives the transport stream packet 210, and determines whether or not to transmit the multimedia data in the transport stream packet 210 to the storage unit 120 according to the transport packet header H21. Then, the recorder 110 receives the next transport stream packet 220, and determines whether or not to transmit the multimedia data in the transport stream packet 220 to the storage unit 120 according to the transport packet header H22. Processing of the transport stream packets 230-250 by the recorder 110 is deduced by analogy. On the other hand, the storage unit 120 includes a plurality of storage blocks BL11-BL17, wherein sizes of the storage blocks BL11-BL17 relate to an optimal storage performance of the memory 101. Moreover, the storage blocks BL11-BL17 may have the same size, or the storage blocks BL11-BL17 may have different sizes and are managed through a table.

Further, the storage blocks BL11-BL17 are respectively used for storing a program stream packet, so that the storage unit 120 may generate the program stream

PS and transmit it to the memory 101. Moreover, the storage blocks BL11-BL17 are respectively set to an idle state, a collecting state or a completed state according to utilization states of storage spaces thereof. For example, as shown in FIG. 1B, the storage spaces of the storage blocks BL11, BL12 and BL14 are fully filled with the multimedia data, so that they are set to the completed state. Moreover, though the storage blocks BL13 and BL15 are stored with the multimedia data, they still have remained storage spaces, so that they are set to the collecting state. The remained storage blocks BL16-BL17 are not stored with the multimedia data, so that they are set to the idle state. Moreover, the multimedia data can be grouped into video data or audio data according to its data type. Therefore, if the storage block BL11 is used for storing the video data, it can provide the program stream packet of a video type. Comparatively, if the storage block BL12 is used for storing the audio data, it can provide the program stream packet of an audio type.

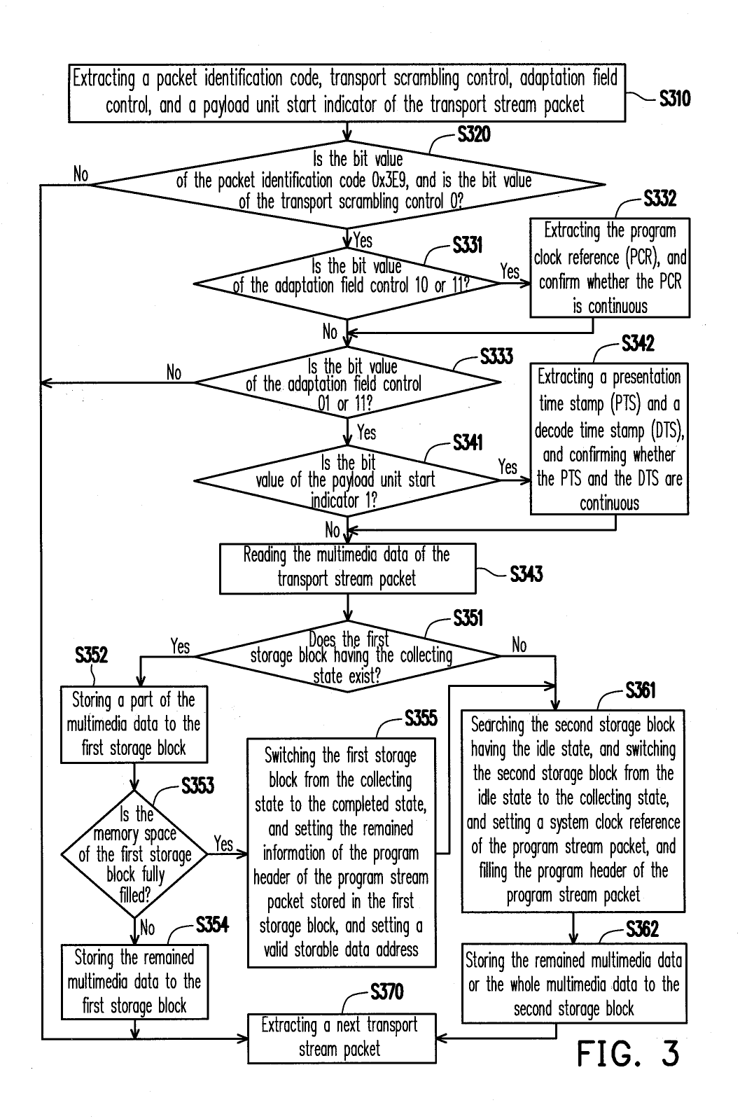

It should be noticed that during a process that the recorder 110 transmits the multimedia data to the storage unit 120, converting of the multimedia data is simultaneously performed, and the related multimedia data converting method is shown in FIG. 3. FIG. 3 is a flowchart illustrating a method for converting multimedia data. Referring to FIG. 1B and FIG. 3, in step S310, the recorder 110 extracts the control information (for example, the transport scrambling control, the packet identification code, the adaptation field control, and the payload unit start indicator, etc.) within the transport packet header H21 of the transport stream packet 210.

Then, in step S320, the recorder 110 determines whether or not to process the transport stream packet 210 according to bit values of the transport scrambling control and the packet identification code(PID).

For example, if the bit value of the packet identification code(PID) to be recorded is 0x3E9, the recorder 110 determines whether the transport stream packet 210 is data desired to be recorded by the user according to whether the bit value of the packet identification code(PID) is 0x3E9. Wherein, if the bit value of the packet identification code(PID) is not 0x3E9, the recorder 110 selects the next transport stream packet 220 (step S370). Moreover, if the bit value of the packet identification code(PID) is 0x3E9, the recorder 110 further determines whether the transport stream packet 210 is encrypted according to the bit value of the transport scrambling control. For example, the multimedia data of pay-per-view programs are all encrypted. Wherein, if the bit value of the transport scrambling control is not 0, it represents that the transport stream packet 210 is encrypted, so that the recorder 110 selects the next transport stream packet 220 (the step S370). If the packet identification code(PID) indicates that the transport stream packet 210 is the data to be recorded, and the bit value of the transport scrambling control is 0, the recorder 110 processes the transport stream packet 210.

Moreover, during a process of processing the transport stream packet 210 as that shown in steps S331-S333, the recorder 110 determines whether the transport stream packet 210 includes the multimedia data and a program clock reference (PCR) according to the bit value of the adaptation field control of the transport stream packet 210.

For example, an information size of the adaptation field control is 2 bits, so that the bit value has four states of “00”, “01”, “10” and “11”, wherein the state “00” is undefined, a second (counting from LSB) bit is used for determining whether the transport stream packet includes the adaption_filed which may has PCR, and a first bit is used for determining whether the transport stream packet includes the multimedia data. Therefore, in an actual application, as that shown in the step S331, the recorder 110 compares the bit value of the adaptation field control to the state “10” or the state “11”, so as to determine whether the transport stream packet 210 includes the PCR. If the bit value of the adaptation field control is “10” or “11”, the recorder 110 extracts the PCR corresponding to the transport stream packet 210, and determines whether the PCR is continuous.

Moreover, regardless whether the transport stream packet 210 includes the PCR, the recorder 110 compares the bit value of the adaptation field control to the state “01” or the state “11”, so as to determine whether the transport stream packet 210 includes the multimedia data. If the bit value of the adaptation field control is not the state “01” or the state “11”, it represents that the transport stream packet 210 does not contain the multimedia data, so that the recorder 110 selects the next transport stream packet 220 (step S370). Moreover, if the bit value of the adaptation field control is the state “01” or the state “11”, it represents that the transport stream packet 210 contains the multimedia data, so that recorder 110 reads the multimedia data of the transport stream packet 210.

During a process of reading the multimedia data of the transport stream packet 210 as that shown in steps S341-S343, the recorder 110 determines whether the packet payload D21 of the transport stream packet 210 includes a header of a packetized element stream (PES) according to the bit value of the payload unit start indicator of the transport stream packet 210. Wherein, if the bit value of the payload unit start indicator is 1, it represents that the packet payload D21 of the transport stream packet 210 includes the header of the PES.

Now, the recorder 110 reads a presentation time stamp (PTS) and a decoding time stamp (DTS) of the transport stream packet 210 according to the header of the PES, and confirms whether the PTS and the DTS are continuous, so as to adjusts time offsets of the PTS, the DTS and the PCR to be continuous with the time of a previous multimedia data. Moreover, in the step S343, the recorder 110 can read the multimedia data of the transport stream packet 210 by skipping the header of the PES. On the other hand, if the bit value of the payload unit start indicator is 0, it represents that the packet payload D21 of the transport stream packet 210 is an element stream (ES), namely, all of the packet payload D21 is the multimedia data, so that in the step S343, the recorder 110 can directly read the multimedia of the transport stream packet 210.

After reading the multimedia of the transport stream packet 210, in step S351, the recorder 110 determines whether a first storage block having the collecting state exists. For example, if the multimedia data of the transport stream packet 210 is the audio data, the recorder 110 searches the storage block BL13 having the collecting state, and sets the storage block BL13 as the first storage block. If the multimedia data of the transport stream packet 210 is the video data, the recorder 110 searches the storage block BL15 having the collecting state, and sets the storage block BL15 as the first storage block.

If the first storage block exists, in steps S352 and S353, the recorder 110 stores a part of the multimedia data of the transport stream packet 210 by using the remained memory space of the first storage block, and determines whether the memory space of the first storage block is fully filled. If the memory space of the first storage block is not fully filled, in the step S354, the recorder 110 stores the remained multimedia data in the transport stream packet 210 to the first storage block. On the other hand, if the memory space of the first storage block is fully filled, in the step S355, the first storage block is switched from the collecting state to the completed state, and the recorder 110 sets the remained information (for example, a length of the program stream packet) of the program header of the program stream packet stored in the first storage block, and the recorder 110 further searches continuous and adjacent storage blocks having the completed state from the storage blocks, so as to set a valid storable data memory address.

For example, before the multimedia data of the transport stream packet 210 is stored, the valid storable data memory address of the storage unit 120 is as that shown by an arrow 151. During a process of storing the multimedia data of the transport stream packet 210, if the storage block BL13 is the first storage block, and the storage block BL13 is switched to the completed state as the multimedia data of the transport stream packet 210 is stored, since now the continuous and adjacent storage blocks BL11-BL14 all have the completed state, the valid storable data memory address is set to an memory address as that shown by an arrow 152. Comparatively, during the process of storing the multimedia data of the transport stream packet 210, if the storage block BL15 is the first storage block, and the storage block BL15 is switched to the completed state as the multimedia data of the transport stream packet 210 is stored, since now the storage block BL13 in the collecting state exists between the storage block BL15 and the valid storable data memory address marked by the arrow 151, the recorder 110 still sets the memory address marked by the arrow 151 as the valid storable data memory address. It should be noticed that the memory 101 extracts and stores the program stream from the multimedia data converter 100 according to the valid storable data memory address. Moreover, after the memory 101 accesses the program stream according to the valid storable data memory address, the continues adjacent storage blocks having the completed state in the storage blocks BL11-BL17 are switched from the completed state to the idle state.

It should be noticed that before the multimedia data of the transport stream packet 210 is stored, the recorder 110 further compares the valid storable data memory address with a random access point (RAP) memory address to determine whether or not to fill the remained memory space of the first storage block with a padding stream. In this way, if the post-end memory 101 has a size limitation of the file system, the recorder 101 stores all of the previous program stream packets to a current file when a next RAP memory address is appeared, and stores the program stream packets corresponding to the next RAP memory address to a new file. Comparatively, the post-end memory 101 makes the file system to comply with a data amount limitation through an auto-cut mechanism.

If the recorder 110 determines that the first storage block does not exist, or the recorder 110 determines that the memory space of the first storage block is fully filled, in step S361, the recorder 110 selects a second storage block having the idle state from the storage blocks, and switches the second block from the idle state to the collecting state. For example, the storage blocks BL16-BL17 are now in the idle state, so that the recorder 110 selects the storage block BL16 to serve as the second storage block from the storage blocks BL16-BL17 according to an arranging sequence of the storage blocks, and switches the idle state of the storage block BL16 to the collecting state.

Besides, when the storage block BL16 is selected, the recorder 110 further sets a system clock reference (SCR) of the program stream packet stored in the second storage block, and fills a program header of the program stream packet stored in the second storage block. It should be noticed that during a processing process of the transport stream packet 210, if the recorder 110 extracts the PCR from the transport stream packet 210, the SCR of the program stream packet stored in the second storage block can be set with reference of the PCR of the transport stream packet 210. On the other hand, during the processing process of the transport stream packet 210, if the PCR is not extracted, to ensure a monotonic increasing of the SCR of the program stream packet, the recorder 110 sets the SCR of the program stream packet according to a previously extracted PCR. Moreover, during the processing process of the transport stream packet 210, if the recorder 110 extracts the PTS and the DTS from the transport stream packet 210, and accordingly determines that there is a time interruption between the transport stream packet 210 and a previous transport stream packet, the recorder 110 can adjust the time offsets of the PTS, the DTS and the PCR to avoid the SCRs of two adjacent transport stream packets exceeding a specified time difference, for example, a time difference of an ISO/IEC 13818-1 specification is 100 milliseconds.

In other words, when the storage block BL16 is selected, a sequence and time information of the program stream packet stored in the storage block BL16 are determined, and a program header field of the program stream packet is filled. Then, as shown in step S362, if the first storage block does not exist, the multimedia data of the transport stream packet 210 is integrally stored in the second storage block. Moreover, if the first storage block exists though the memory space thereof is not enough to store the multimedia data of the transport stream packet 210, a part of the multimedia data of the transport stream packet 210 is then stored in the second storage block.

After processing of the multimedia data of the transport stream packet 210 is completed, in step S370, the recorder 110 selects the next transport stream packet 220 for processing, as that shown in the step S320, the recorder 110 determines whether or not to process the selected transport stream packet 220. If the transport stream packet 220 is about to be processed, the recorder 110 determines whether the transport stream packet 220 includes the multimedia data and the PCR according to the steps S331-S333, and if the transport stream packet 220 includes the multimedia data, the multimedia data of the transport stream packet 220 is read according to the steps S341-S343. Then, the recorder 110 stores the multimedia data of the transport stream packet 220 to the storage unit 120 according to the steps S351-S355 and the steps S361-S362. Processing of the transport stream packets 230-250 by the recorder 110 can be deduced by analogy.

In summary, when the program stream packets are collected, the multimedia data is directly stored to the divided storage blocks in sequence, and a sequence and time information of the program stream packet are determined when the storage block is selected. Moreover, when the storage block is switched to the completed state, the remained information of the program header of the program stream packet is set. In this way, utilization of a memory used for collecting data during an intermediate process in the conventional technique is unnecessary, and data copy operation executed after the program stream packet is constructed can be saved. Comparatively, resource consumption of the whole multimedia data converter can be reduced, so as to greatly reduce a performance loading of an embedded system.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A multimedia data converter, for converting a transport stream to a program stream, the multimedia data converter comprising:
a storage unit, comprising a plurality of storage blocks, wherein the storage blocks respectively store a program stream packet used for forming the program stream, and the storage blocks are respectively set to an idle state, a collecting state or a completed state; and
a recorder, for selecting a plurality of transport stream packets from the transport stream, and determining whether each of the transport stream packets comprises a multimedia data,
wherein the recorder selects a first storage block having the collecting state from the storage blocks for storing the multimedia data, and determines whether or not to select a second storage block having the idle state from the storage blocks in sequence according to remained memory space of the first storage block, so as to use the first storage block or the second storage block to store the multimedia data, wherein when the second storage block is selected, the recorder sets a system clock reference (SCR) of the program stream packet stored in the second storage block, and fills a program header of the program stream packet stored in the second storage block.

2. The multimedia data converter as claimed in claim 1, wherein the recorder further determines whether the first storage block exists, and if the first storage block does not exist, the recorder searches the second storage block for directly storing the multimedia data to the second storage block.

3. The multimedia data converter as claimed in claim 2, wherein if the first storage block exists, the recorder stores a part of the multimedia data to the first storage block, and determines whether a memory space of the first storage block is fully filled, wherein if the memory space of the first storage block is not fully filled, the recorder stores the remained multimedia data to the first storage block, and if the memory space of the first storage block is fully filled, the recorder switches the first storage block from the collecting state to the completed state, and searches the second storage block, so as to store the remained multimedia data to the second storage block.

4. The multimedia data converter as claimed in claim 3, wherein when the second storage block is searched out, the recorder switches the second storage block from the idle state to the collecting state.

5. The multimedia data converter as claimed in claim 3, wherein when the memory space of the first storage block is fully filled, the recorder sets remained information of a program header of the program stream packet stored in the first storage block.

6. The multimedia data converter as claimed in claim 1, wherein the transport stream packets respectively comprise a transport packet header and a packet payload, and the recorder selects one of the transport stream packets to serve as a specific packet, and determines whether or not to process the specific packet according to the transport packet header of the specific packet, and during a processing process of the specific packet, the recorder determines whether the specific packet has the multimedia data and a program clock reference (PCR) according to the transport packet header of the specific packet.

7. The multimedia data converter as claimed in claim 6, wherein when the specific packet has the PCR, the recorder further determines whether the PCR is continuous, so as to serve as a reference for setting the SCR of the program stream packet.

8. The multimedia data converter as claimed in claim 6, wherein if the specific packet has the multimedia data, the recorder reads the multimedia data, and determines whether the packet payload of the specific packet comprises a header of a packetized element stream (PES) according to the transport packet header of the specific packet, so as to read a presentation time stamp (PTS) and a decoding time stamp (DTS) of the specific packet according to the header of the PES.

9. The multimedia data converter as claimed in claim 8, wherein the recorder further confirms whether the PTS and the DTS are continuous, so as to determine whether or not to adjust time offsets of the PTS, the DTS and the PCR.

10. The multimedia data converter as claimed in claim 1, wherein when the memory space of the first storage block is fully filled, the recorder searches continuous and adjacent storage blocks having the completed state from the storage blocks, so as to set a valid storable data memory address.

11. The multimedia data converter as claimed in claim 10, wherein before the multimedia data is stored, the recorder further compares the valid storable data memory address with a random access point (RAP) memory address to determine whether or not to fill the remained memory space of the first storage block with a padding stream.

12. The multimedia data converter as claimed in claim 1, wherein the storage blocks have the same size, or the storage blocks have different sizes and are managed through a table.

13. A multimedia playing apparatus, comprising:
a multimedia data converter, for converting a transport stream to a program stream, and comprising:
a storage unit, comprising a plurality of storage blocks, wherein the storage blocks respectively store a program stream packet used for forming the program stream, and the storage blocks are respectively set to an idle state, a collecting state or a completed state; and
a recorder, for selecting a plurality of transport stream packets from the transport stream, and determining whether each of the transport stream packets comprises a multimedia data, wherein the recorder selects a first storage block having the collecting state from the storage blocks for storing the multimedia data, and determines whether or not to select a second storage block having the idle state from the storage blocks in sequence according to remained memory space of the first storage block, so as to use the first storage block or the second storage block to store the multimedia data, wherein when the second storage block is selected, the recorder sets a system clock reference (SCR) of the program stream packet stored in the second storage block, and fills a program header of the program stream packet stored in the second storage block;
a memory, for extracting and storing the program stream received from the multimedia data converter according to a valid storable data memory address; and
a player, for decoding the transport stream or the program stream to directly play the multimedia data in the transport stream or play the multimedia data in the program stream stored in the memory.

14. The multimedia playing apparatus as claimed in claim 13, wherein the recorder further determines whether the first storage block exists, and if the first storage block does not exist, the recorder searches the second storage block for directly storing the multimedia data to the second storage block.

15. The multimedia playing apparatus as claimed in claim 14, wherein if the first storage block exists, the recorder stores a part of the multimedia data to the first storage block, and determines whether a memory space of the first storage block is fully filled, wherein if the memory space of the first storage block is not fully filled, the recorder stores the remained multimedia data to the first storage block, and if the memory space of the first storage block is fully filled, the recorder switches the first storage block from the collecting state to the completed state, and searches the second storage block, so as to store the remained multimedia data to the second storage block.

16. The multimedia playing apparatus as claimed in claim 15, wherein when the second storage block is searched out, the recorder switches the second storage block from the idle state to the collecting state.

17. The multimedia playing apparatus as claimed in claim 15, wherein when the memory space of the first storage block is fully filled, the recorder sets remained information of a program header of the program stream packet stored in the first storage block.

18. The multimedia playing apparatus as claimed in claim 13, wherein the transport stream packets respectively comprise a transport packet header and a packet payload, and the recorder selects one of the transport stream packets to serve as a specific packet, and determines whether or not to process the specific packet according to the transport packet header of the specific packet, and during a processing process of the specific packet, the recorder determines whether the specific packet has the multimedia data and a program clock reference (PCR) according to the transport packet header of the specific packet.

19. The multimedia playing apparatus as claimed in claim 18, wherein when the specific packet has the PCR, the recorder further determines whether the PCR is continuous, so as to serve as a reference for setting the SCR of the program stream packet.

20. The multimedia playing apparatus as claimed in claim 18, wherein if the specific packet has the multimedia data, the recorder reads the multimedia data, and determines whether the packet payload of the specific packet comprises a packet header according to the transport packet header of the specific packet, so as to read a presentation time stamp (PTS) and a decoding time stamp (DTS) of the specific packet according to the packet header.

21. The multimedia playing apparatus as claimed in claim 20, wherein the recorder further confirms whether the PTS and the DTS are continuous, so as to determine whether or not to adjust time offsets of the PTS, the DTS and the PCR.

22. The multimedia playing apparatus as claimed in claim 13, wherein when the memory space of the first storage block is fully filled, the recorder searches continuous and adjacent storage blocks having the completed state from the storage blocks, so as to set the valid storable data memory address, and after the recorder accesses the program stream according to the valid storable data memory address, the recorder switches the continuous adjacent storage block having the completed state in the storage blocks from the completed state to the idle state.

23. The multimedia playing apparatus as claimed in claim 22, wherein before the multimedia data is stored, the recorder further compares the valid storable data memory address with a random access point (RAP) memory address to determine whether or not to fill the remained memory space of the first storage block with a padding stream.

24. The multimedia playing apparatus as claimed in claim 13, wherein the storage blocks have the same size, or the storage blocks have different sizes and are managed through a table.

25. A method for converting multimedia data, for converting a transport stream to a program stream, and the method for converting multimedia data comprising:
providing a plurality of storage blocks, wherein the storage blocks respectively store a program stream packet used for forming the program stream, and the storage blocks are respectively set to an idle state, a collecting state or a completed state;
selecting a plurality of transport stream packets from the transport stream, and determining whether each of the transport stream packets comprises a multimedia data;
selecting a first storage block having the collecting state from the storage blocks for storing the multimedia data, and determining whether or not to select a second storage block having the idle state from the storage blocks in sequence according to remained memory space of the first storage block, so as to use the first storage block or the second storage block to store the multimedia data; and
when the second storage block is selected, setting a system clock reference (SCR) of the program stream packet stored in the second storage block, and filling a program header of the program stream packet stored in the second storage block.

26. The method for converting multimedia data as claimed in claim 25, wherein the step of selecting the first storage block having the collecting state from the storage blocks for storing the multimedia data, and determining whether or not to select the second storage block having the idle state from the storage blocks in sequence according to the remained memory space of the first storage block, so as to use the first storage block or the second storage block to store the multimedia data comprises:
determining whether the first storage block having the collecting state exists;
if the first storage block does not exist, searching the second storage block to directly store the multimedia data to the second storage block;
if the first storage block exists, storing a part of the multimedia data to the first storage block, and determining whether a memory space of the first storage block is fully filled;
if the memory space of the first storage block is not fully filled, storing the remained multimedia data to the first storage block; and
if the memory space of the first storage block is fully filled, switching the first storage block from the collecting state to the completed state, and searching the second storage block, so as to store the remained multimedia data to the second storage block.

27. The method for converting multimedia data as claimed in claim 26, further comprising:
switching the second storage block from the idle state to the collecting state when the second storage block is searched out.

28. The method for converting multimedia data as claimed in claim 26, further comprising:
setting remained information of a program header of the program stream packet stored in the first storage block when the memory space of the first storage block is fully filled.

29. The method for converting multimedia data as claimed in claim 25, wherein the transport stream packets respectively comprise a transport packet header and a packet payload, and the step of selecting the transport stream packets from the transport stream, and determining whether each of the transport stream packets comprises the multimedia data comprises:
selecting one of the transport stream packets to serve as a specific packet, and determining whether or not to process the specific packet according to the transport packet header of the specific packet;
determining whether the specific packet has the multimedia data and a program clock reference (PCR) according to the transport packet header of the specific packet during a processing process of the specific packet;
determining whether the PCR is continuous when the specific packet has the PCR, so as to serve as a reference for setting the SCR of the program stream packet;
if the specific packet has the multimedia data, reading the multimedia data, and determining whether the packet payload of the specific packet comprises a header of a packetized element stream (PES) according to the transport packet header of the specific packet, so as to read a presentation time stamp (PTS) and a decoding time stamp (DTS) of the specific packet according to the header of the PES; and
confirming whether the PTS and the DTS are continuous, so as to determine whether or not to adjust time offsets of the PTS, the DTS and the PCR.

30. The method for converting multimedia data as claimed in claim 25, further comprising:
searching continuous and adjacent storage blocks having the completed state from the storage blocks when the memory space of the first storage block is fully filled, so as to set a valid storable data memory address.

31. The method for converting multimedia data as claimed in claim 30, further comprising:
comparing the valid storable data memory address with a random access point (RAP) memory address before the multimedia data is stored, so as to determine whether or not to fill the remained memory space of the first storage block with a padding stream.

32. The method for converting multimedia data as claimed in claim 25, wherein the storage blocks have the same size, or the storage blocks have different sizes and are managed through a table.
